(19) United States
(12) Patent Application Publication
(10) Pub. No.: US 2024/0174555 A1
(43) Pub. Date: May 30, 2024

(54) METHODS OF INCREASING SCRAP GLASS RECYCLING

(71) Applicants: Owens Corning Intellectual Capital, LLC, Toledo, OH (US); Pittsburgh Corning Europe NV, Tessenderlo (BE)

(72) Inventors: Stijn Verlaak, Hasselt (BE); Joelle Boehmer, Pataskala, OH (US); Steven R. Badger, Pittsburgh, PA (US)

(21) Appl. No.: 18/522,506

(22) Filed: Nov. 29, 2023

Related U.S. Application Data
(60) Provisional application No. 63/385,276, filed on Nov. 29, 2022.

(51) Int. Cl. C03C 11/00; C03C 1/00; C03C 3/087

(52) U.S. Cl. CPC C03C 11/007; C03C 1/002; C03C 3/087; C03C 2203/10

(57) ABSTRACT

Disclosed herein are methods of reusing at least a portion of the scrap glass generated in a cellular glass manufacturing process by introducing the scrap glass back into a cellular glass manufacturing process. The methods comprise changing the overall glass composition allowing for higher oxidizer content, which, in turn, allows for inclusion of more scrap material in the glass melt and the cellular glass production process. In particular, the glass composition in the melt is treated to increase the amount of an oxidizer (e.g., MnO₂) to amounts above those that are used in conventional manufacturing processes, while also maintaining important physical properties in the ultimate cellular glass product.

### CROSS-REFERENCE

This application claims priority to and the benefit of U.S. provisional patent application No. 63/385,276, filed Nov. 29, 2022, the content of which is hereby incorporated by reference herein.

### FIELD

The inventive concepts described in the present disclosure relate to cellular glass, and more particularly to methods of reducing the unnecessary waste attendant with conventional cellular glass production processes.

### BACKGROUND

Cellular glass is a solid foamed product formed by expanding gases in a molten glass matrix. Cellular glasses are a special class of lightweight glass materials having numerous small cells entrained within a rigid matrix. A common technique of making cellular glasses includes the following steps: 1) melting glass raw material at high temperature to form a glass, 2) grinding the glass into a powder while introducing foaming agents, 3) heating the ground glass feedstock, and 4) foaming the ground glass powder at high temperature. The gases produced during the foaming stage form cells within the glass matrix, similar to traditional foams. Due to cellular glass's unique combination of insulative capacity, mechanical strength, chemical stability, and fire resistance, products based thereon are useful in a variety of industries (see ASTM C552 for classification of cellular glass thermal insulation). Particularly, closed cell cellular glass is formed by capturing the gas within the cells, giving it improved insulative capacity and stable thermal conductivity compared to cellular glasses with open cells. Moreover, cellular glass with closed cells is vapor impermeable, which is a key factor in many applications.

Cellular glass has a relatively high insulative capacity, making it a preferred insulating material for certain applications, especially those that can take advantage of the other unique properties of cellular glass, e.g., its high compressive strength. However, due to its rigid structure, substantial scrap material often results from the manufacturing process (e.g., due to cutting of cellular glass blocks to meet manufacturing specifications). Further, said scrap material includes an undesirable amount of carbon, making reuse of the scrap unduly expensive or unfeasible.

Prior attempts at producing cellular glass products using scrap glass materials have often resulted in poor quality foamed material (e.g., open cells, reduced insulative capacity). Said decrease in desirable cellular glass quality may be due to the necessary addition of oxidizers, such as MnO₂, to the grinding step. Therefore, there is still a need for an effective method and composition for the reuse of scrap glass materials in cellular glass manufacturing.

### SUMMARY

Disclosed herein are methods and compositions for the modification and reuse/recycling of scrap glass materials produced during cellular glass manufacturing. An advantage of cellular glass modification/recycling is that it allows for scrap materials to be reintroduced into the glass melting furnace (hereinafter, “melter”) in larger amounts than previously possible; thus, potentially reducing the environmental impact of waste cellular glass materials and cost of cellular glass production. The general inventive concepts are based, in part, on the discovery that by introducing scrap materials (whether alone or in combination with raw materials) and a source of oxygen in the melter, cellular glass products can be produced using larger amounts of scrap materials while retaining desirable properties such as hydrolytic resistance, e-modulus, chemical durability, closed cell content, thermal conductivity, and mechanical strength among other desirable cellular glass properties.

Various exemplary embodiments of the present inventive concepts are directed to a cellular glass product made from a glass composition comprising MnO in an amount of 2% to 10% by weight and at least one of the following: SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; and BaO+SrO in an amount of 0% to 0.3% by weight. In certain exemplary embodiments, the cellular glass product meets at least one of the following: is a closed cell foam; has a density of about 75 kg/m³ to 300 kg/m³; has a thermal conductivity of 0.033 W/mK to 0.06 W/mK; and has a compressive strength of 0.4 MPa to 2.4 MPa. In certain exemplary embodiments, the glass composition comprises MnO in an amount of 2% to 10% by weight, SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18% by weight; SO₃ in an amount of 0.2% to 0.9% by weight; Fe₂O₃ in an amount from 1% to 6% by weight; BaO+SrO in an amount of 0% to 0.3% by weight; and TiO₂ in an amount of 0% to 0.5% by weight.

Various exemplary embodiments of the present inventive concepts are directed to a cellular glass product made from a glass composition comprising MnO in an amount of 0.4% to 10% by weight in combination with at least one of BaO, SrO, and combinations thereof in an amount of 0.3% to 2% by weight and at least one of the following: SiO₂ in an amount from 55% to 75% by weight; Al₂O₃ in an amount from 1% to 10% by weight; CaO+MgO in an amount from 4% to 11% by weight; and Na₂O+K₂O+Li₂O in an amount from 12% to 18%% by weight. In certain exemplary embodiments, the cellular glass product meets at least one of the following: is a closed cell foam; has a density of about 75 kg/m³ to 300 kg/m³; has a thermal conductivity of 0.033 W/mK to 0.06 W/mK; and has a compressive strength of 0.4 MPa to 2.4 MPa. In certain exemplary embodiments, the glass composition comprises MnO in an amount of 0.4% to 10% by weight in combination with BaO and SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; BaO+SrO in an amount of 0.3% to 2.0% by weight; and TiO₂ in an amount of 0% to 0.5% by weight.

Various exemplary embodiments disclose methods for producing a cellular glass product comprising at least a portion of scrap material or recycled cullet. The method comprises providing a source of raw materials in a melter, wherein the raw materials include two or more of virgin material, scrap material, and recycled cullet; providing a source of an oxidizing agent into the melter and mixing the oxidizing agent with the raw materials to form a glass melt, wherein the oxidizing agent is included in an amount to achieve a predetermined level of the oxidizing agent in the glass melt; cooling the glass melt; and subjecting a resulting glass material to a cellular glass production process.

### BRIEF DESCRIPTION OF THE DRAWINGS

The general inventive concepts will be described in greater detail with reference to the drawings in which:

FIG. 1 shows lab-scale cellular foam samples made using a cellular glass mixture according to the general inventive concepts.

FIG. 2 shows a lab-scale foam sample made using a conventional glass designed for cellulating, containing ≤2 wt. % MnO₂.

FIG. 3 shows lab-scale cellular foam samples made using a cellular glass mixture according to the general inventive concepts and an elevated amount of oxidizer.

FIG. 4 is a graph showing thermal conductivity versus foam density for a conventional cellular glass product and cellular glass products produced according to the general inventive concepts.

FIG. 5 is a graph showing compressive strength versus foam density for a conventional cellular glass product and cellular glass products produced according to the general inventive concepts.

FIG. 6 is a graph showing E-modulus versus foam density for a conventional cellular glass product and cellular glass products produced according to the general inventive concepts.

FIG. 7 shows an image of a portion of a foam sample with open cells, made by incorporating additional oxides into a ball mill (i.e., solid state mixing) during production.

FIG. 8 shows an image of a portion of a foam sample with closed cells, made by incorporating additional oxides into a foam making process according to the general inventive concepts.

### DETAILED DESCRIPTION

While various exemplary compositions, materials, and methods are described herein, other compositions, materials, and methods similar or equivalent to those described herein are encompassed by the general concepts of the present disclosure. While the general concepts are susceptible of embodiment in many different forms, at least one specific embodiment of such concepts is described herein in detail with the understanding that the present disclosure is to be considered as an exemplification of the principles of the general inventive concepts.

Unless defined otherwise, all technical and scientific terms used herein have the same meaning as commonly understood by one of ordinary skill in the art to which the subject matter of the present disclosure belongs.

As used herein, the term “raw material” refers to a starting material used for melting a glass suitable for foaming in the cellular glass production process and may include both virgin materials, recycled materials, and scrap materials. “Virgin” material refers to materials that are typically the result of mining or chemical synthesis and not recycled, reused, or repurposed from other products or processes.

As used herein, the term “scrap material” refers to recycled, reused, scrap, and/or waste glass material resulting from glass production process or from cellular glass products. The glass composition of scrap material often contains a higher level of undesirable reduced oxides and carbon contamination than virgin material.

As used herein, the term “recycled cullet” refers to post-consumer recycled glass not resulting from cellular glass products, e.g., post-consumer float glass or container glass. Such recycled cullet often contains undesirable organic contamination.

As used herein, the term “foamable glass material” refers to any glass material which can be foamed and which is formed by combining virgin materials, scrap material and recycled cullet, as well as other materials (e.g., an oxidizer), in a melter to form a glass melt with a desired composition.

As used herein, the term “glass melt” refers to the melt resulting from homogenizing raw materials, often by dissolving the constituent oxides at high temperatures, e.g., in a melter.

As used herein, the term “cellular glass product” refers to material that results from subjecting a foamable glass material to a cellulating process (e.g., sintering, foaming, annealing, etc.). The product may then undergo additional processing or finishing (e.g., cutting). Generally, the cellular glass product according to the general inventive concepts is a cellular glass thermal insulation according to ASTM C552 and/or EN 13167.

As used herein, the terms “weight percent,” “% by weight,” “wt. %,” “wt %,” and “percent by weight” may be used interchangeably and are meant to denote the weight percent (or percent by weight) based on the total composition unless otherwise noted.

Cellular glass is a rigid non-porous insulation material. Cellular glass is generally durable, chemically resistant, fire resistant, vapor tight, and has a high strength to weight ratio—making it an ideal insulator for use in a variety of harsh conditions and/or when mechanical strength is also an important property.

Cellular glass can be manufactured by many methods, using compositions based on various kinds of glass feedstock and foaming agents. Conventional processes for forming cellular glass products generally include grinding glass material(s) with a foaming agent and optionally, an oxidizing agent, each in a solid phase, in a ball mill to intermix the materials and reduce the material particle size. However, since the starting materials are intermixed in the solid phase, this method does not ensure a high level of distribution homogeneity throughout the mixture.

According to the present inventive concepts, rather than mixing the starting raw materials in the solid phase (as is done in conventional processes, producing foam product with an undesirable open-cell character), the raw materials are optionally ground and then added to and mixed in a melter to produce a glass melt. The materials molten to produce the glass melt may comprise raw material, virgin materials, scrap material, recycled cullet, or mixtures thereof. One or more oxidizing agents (e.g., MnO₂) are introduced directly into the melter and homogenously combined with the raw materials, forming a glass melt. The glass melt is then cooled, and the resulting foamable glass material is either stored for later use or sent onto the next step of the process.

The next step involves grinding the cooled glass into small particles, while introducing a foaming agent (e.g., a source of carbon). Grinding reduces the size of the glass particles, covers the glass particles with foaming agent particles, and forms a ground glass batch.

After grinding, the ground glass with foaming agent batch is sintered, whereby the glass particles soften and flow together into a viscous glass matrix, and the foaming agent particles get embedded therein. As the foaming agent is embedded into the glass matrix, any free or reactive oxygen in the glass (e.g. bound to transition metals) reacts with the carbon to form CO₂, which will nucleate and form a bubble near the carbon particle.

Thus, in general, production of cellular glass insulation involves the reaction of an oxygen-rich glass with carbon to generate the CO₂ gas which fills the cells of the cellular glass. While the glass melt is required to be highly oxidized, the resulting cellular glass is in the reduced state (most oxidized elements in the melter glass will be in a reduced state in any resulting scrap) and contains carbon.

This reduced state typically limits the amount of scrap material (or recycled cullet) that can be recycled (e.g., via direct combination with raw materials for reintroduction into the melting process), because adding scrap material, which is in a reduced state relative to what is necessary for effective cellulating (i.e., it has low foaming capacity), to the raw/virgin materials has the effect of lowering the overall oxidation state of the glass melt and impairs the cellulating process downstream. Similarly, the organic contamination in recycled cullet will lower the overall oxidation state of the glass feedstock as well, equally impairing the cellulating process downstream. One previous approach to addressing this problem is the addition of oxidizing agents to the ground glass batch (i.e., in the solid phase after the melter), but this approach has limitations. For example, attempts at adding a source of oxygen at the grinding stage have been shown to impair the desirable properties of the ultimate product (e.g., open cells in the cellular glass, reduced insulative capacity, etc.).

Thus, the general inventive concepts are based, in part, on the discovery that the oxidation state of a foamable glass material can be increased/improved by introduction of a source of oxygen/oxidizing agent directly into a melter, during the melting stage. By introducing the source of oxygen (e.g., MnO₂) at this stage of the process, scrap materials and/or recycled cullet can be utilized in the cellular glass forming process at higher concentrations, while also maintaining the desirable properties of the foamable glass material to produce cellular glass insulation products with desirable properties (e.g., closed cell content, insulative capacity, mechanical strength).

One important consideration for reintroducing recycled cullet or scrap materials into a cellular glass production process is how much additional oxidizing agent can be added to the materials in the melter without impairing the important properties of the cellular glass product.

While not wishing to be bound by theory, Applicants have found that when using scrap material in a cellular glass production process, it is possible to (re)introduce oxidizing agents (e.g., manganese oxide in all its forms, such as MnO₂ and MnO; nitrate in its all forms such as NaNO₃; iron oxide in all forms such as Fe₂O₃; and sulfate in all forms such as Na₂SO₄,) to achieve a suitable threshold of oxidizers in the batch (as they are consumed during foaming and thereby the scrap material has an insufficient concentration remaining). However, introducing large amounts of oxidizing agents in glass batches alters the glass composition and could consequently negatively impact desirable properties of the cellular glass product (e.g., thermal conductivity, strength) or may increase environmental emissions (e.g. SOₓ, NOₓ).

One such oxidizer used in the cellular glass production processes is MnO. Although the oxidizing agents, including MnO, may be described herein in a particular oxidation state, it is to be appreciated that the oxidizing agent may alternatively be present in any oxidization state or a blend of oxidation states (e.g., MnO₂, Mn₂O₃), as appropriate.

Particularly, the cellular glass products disclosed herein can be produced from raw materials that incorporate at least a portion of scrap material and an increased concentration of oxidizing agent (e.g., >2% vs <0.4% by weight), while maintaining the desirable properties of the cellular glass product, e.g., closed cell content, insulative capacity, vapor tightness (water vapor impermeability), and mechanical strength.

In certain embodiments, the general inventive concepts contemplate a cellular glass product that comprises at least a portion of scrap material and has a particular oxide content. In any of the exemplary embodiments, the cellular glass product may comprise manganese oxide (described herein as MnO for simplicity, but it is to be appreciated that the manganese may exist in a variety or mixture of oxidations states, but those of ordinary skill will understand that MnO₂ is the most likely form of the oxide that would be added to a melter in a glass production process, with the caveat being that scrap materials added to the melter also include amounts of MnO, as described above) in an amount of at least 2% by weight of the cellular glass product. In certain exemplary embodiments, the cellular glass product comprises MnO in an amount of up to 10% by weight of the cellular glass product. In certain exemplary embodiments, the cellular glass product comprises MnO in an amount of 2% to 10% by weight of the cellular glass product. In certain exemplary embodiments, the cellular glass product comprises MnO in an amount of 2.1% to 10% by weight of the cellular glass product. In certain exemplary embodiments, the cellular glass product comprises MnO in an amount of 2.2% to 10% by weight of the cellular glass product. In certain exemplary embodiments, the cellular glass product comprises MnO in an amount of 2.3% to 10% by weight of the cellular glass product. In certain exemplary embodiments, the cellular glass product comprises MnO in an amount of 2.4% to 10% by weight of the cellular glass product. In certain exemplary embodiments, the cellular glass product comprises MnO in an amount of 2.5% to 10% by weight of the cellular glass product. In certain exemplary embodiments, the cellular glass product comprises MnO in an amount of 2.6% to 10% by weight of the cellular glass product. In certain exemplary embodiments, the cellular glass comprises MnO in an amount of 2.7% to 10% by weight of the cellular glass product. In certain exemplary embodiments, the cellular glass product comprises MnO in an amount of 2.8% to 10% by weight of the cellular glass product. In certain exemplary embodiments, the cellular glass product comprises MnO in an amount of 2.9% to 10% by weight of the cellular glass product, including any endpoints and subranges therebetween. In certain exemplary embodiments, the cellular glass product comprises MnO in an amount of 3% to 10% by weight of the cellular glass product. In certain exemplary embodiments, the cellular glass product comprises MnO in an amount of 3.1% to 10% by weight of the cellular glass product. In certain exemplary embodiments, the cellular glass product comprises MnO in an amount of 3.2% to 10% by weight of the cellular glass product. In certain exemplary embodiments, the cellular glass product comprises MnO in an amount of 3.3% to 10% by weight of the cellular glass product. In certain exemplary embodiments, the cellular glass product comprises MnO in an amount of 3.4% to 10% by weight of the cellular glass product. In certain exemplary embodiments, the cellular glass product comprises MnO in an amount of 3.5% to 10% by weight of the cellular glass product. In certain exemplary embodiments, the cellular glass product comprises MnO in an amount of 3.6% to 10% by weight of the cellular glass product. In certain exemplary embodiments, the cellular glass product comprises MnO in an amount of 3.7% to 10% by weight of the cellular glass product. In certain exemplary embodiments, the cellular glass product comprises MnO in an amount of 3.8% to 10% by weight of the cellular glass product. In certain exemplary embodiments, the cellular glass product comprises MnO in an amount of 3.9% to 10% by weight of the cellular glass product. In certain exemplary embodiments, the cellular glass product comprises MnO in an amount of 4% to 10% by weight of the cellular glass product. In certain exemplary embodiments, the cellular glass product comprises MnO in an amount of 4.1% to 10% by weight of the cellular glass product. In certain exemplary embodiments, the cellular glass product comprises MnO in an amount of 4.2% to 10% by weight of the cellular glass product. In certain exemplary embodiments, the cellular glass product comprises MnO in an amount of 4.3% to 10% by weight of the cellular glass product. In certain exemplary embodiments, the cellular glass product comprises MnO in an amount of 4.4% to 10% by weight of the cellular glass product. In certain exemplary embodiments, the cellular glass comprises MnO in an amount of 4.5% to 10% by weight of the cellular glass product. In certain exemplary embodiments, the cellular glass product comprises MnO in an amount of 4.6% to 10% by weight of the cellular glass product. In certain exemplary embodiments, the cellular glass product comprises MnO in an amount of 4.7% to 10% by weight of the cellular glass product. In certain exemplary embodiments, the cellular glass product comprises MnO in an amount of 4.8% to 10% by weight of the cellular glass product. In certain exemplary embodiments, the cellular glass product comprises MnO in an amount of 4.9% to 10% by weight of the cellular glass product, including any endpoints and subranges therebetween.

In any of the exemplary embodiments, the cellular glass product may comprise MnO in an amount of at least 2% by weight up to 10% by weight of the cellular glass product. In certain exemplary embodiments, the cellular glass product comprises MnO in an amount of 2.1% to 10% by weight of the cellular glass product, including, for example, MnO in an amount of 2.1% to 8% by weight, 2.3% to 7.5% by weight, 2.5% to 7.2% by weight, 2.7% to 7% by weight, 2.9% to 6.7% by weight, 3.0% to 6.5% by weight, 3.2% to 6.3% by weight 3.5% to 6% by weight, and 3.7% to 5.8% by weight of the cellular glass product, including any endpoints and subranges therebetween.

In any of the exemplary embodiments, the cellular glass product comprises MnO in an amount of at least 2% by weight of the cellular glass material, including, for example, at least 2.5% by weight, at least 3% by weight at, at least 3.5% by weight, at least 4% by weight, at least 4.2% by weight, 4.4% by weight, 4.6% by weight, and 4.8% by weight of the cellular glass product, including any endpoints and subranges therebetween.

In certain exemplary embodiments, the cellular glass product comprises MnO in an amount of 5% to 10% by weight of the cellular glass product. In certain exemplary embodiments, the cellular glass product comprises MnO in an amount of 6% to 10% by weight of the cellular glass product. In certain exemplary embodiments, the cellular glass product comprises MnO in an amount of 7% to 10% by weight of the cellular glass product. In certain exemplary embodiments, the cellular glass product comprises MnO in an amount of 8% to 10% by weight of the cellular glass product. In certain exemplary embodiments, the cellular glass product comprises MnO in an amount of 9% to 10% by weight of the cellular glass product, including any endpoints and subranges therebetween.

Apart from the oxidizing agent discussed above, the cellular glass product is produced from a glass composition comprising a variety of oxides, such as SiO₂, Al₂O₃, alkaline earth metal oxides, alkali metal oxides, and iron oxide. For instance, the glass composition may comprise SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; BaO+SrO in an amount of 0% to 0.3% by weight; and TiO₂ in an amount of 0% to 0.5% by weight, based on the total weight of the glass composition. Additionally, the oxidizing agent, such as MnO may be included in an amount from 2% to 10% by weight, based on the total weight of the glass composition or cellular glass product.

In certain exemplary embodiments, the glass composition comprises MnO in an amount of 2% to 10% by weight, SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; BaO+SrO in an amount of 0% to 0.3% by weight; and TiO₂ in an amount of 0% to 0.5% by weight of the glass composition or cellular glass product.

Notwithstanding the above, in some exemplary embodiments, the glass composition may comprise MnO in amounts less than 2% when combined with BaO, SrO, or a combination thereof. Thus, in certain exemplary embodiments, the glass composition comprises 0.4% to 10% by weight MnO when used in a composition comprising at least 0.3 wt. % BaO+SrO. In such embodiments, the glass composition may comprise 0.4 wt. % to less than 10% by weight MnO, including, for example, 0.5% by weight to 8% by weight MnO, 0.5% by weight to 6% by weight, and 0.8% by weight to 5% by weight MnO when used in a composition comprising 0.5% by weight to 5% by weight BaO+SrO, such as, for example, 0.7% by weight to 3% by weight, and 0.9% by weight to 1.5% by weight.

Thus, various exemplary embodiments of the present inventive concepts are directed to a glass composition comprising MnO in an amount of 0.4% to 10% by weight in combination with at least one of BaO and SrO, and at least one of the following: SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; and TiO₂ in an amount of 0% to 0.5% by weight. In certain exemplary embodiments, the glass composition comprises MnO in an amount of 0.4% to 10% by weight in combination with at least one of BaO and SrO, and SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; and TiO₂ in an amount of 0% to 0.5% by weight of the glass composition or cellular glass product.

As mentioned, in certain exemplary embodiments, the glass composition used to produce the cellular glass product will comprise particular amounts or ranges of other ingredients including, but not limited to SiO₂, Al₂O₃, CaO, MgO, Na₂O, K₂O, Li₂O, SO₃, Fe₂O₃, BaO, SrO, and TiO₂, alone or in combination with one another.

Thus, in certain exemplary embodiments, in addition to MnO, the glass composition comprises at least 55% by weight, but no greater than 75% by weight SiO₂, including, for example, at least 57% by weight SiO₂, including at least 59% by weight, at least 60% by weight, at least 62% by weight, and at least 64% by weight. As mentioned above, the glass composition includes no greater than 75% by weight SiO₂, including no greater than 72% by weight, no greater than 70% by weight, no greater than 68% by weight, no greater than 67% by weight, and no greater than 66% by weight. In addition to MnO, the glass composition comprises Al₂O₃ in an amount of at least 1% by weight. In certain exemplary embodiments, the glass composition comprises Al₂O₃ in an amount of less than 10% by weight. In certain exemplary embodiments, the glass composition comprises Al₂O₃ in an amount of 1% to 10% by weight, including 1% to 9% by weight, including 1% to 8%, including 2% to 10% by weight, including 3% to 10% by weight, including 4% to 10% by weight, including 4.5% to 10% by weight, and including 4.5% to 8% by weight, based on the weight of the glass composition or cellular glass product produced therefrom.

The glass composition further comprises CaO+MgO collectively in an amount of at least 4% by weight. In certain exemplary embodiments, the glass composition comprises CaO+MgO in an amount of less than 11% by weight. In certain exemplary embodiments, the glass composition comprises CaO+MgO in an amount of 4% to 11% by weight, including 5% to 10% by weight, including 5.5% to 9%, and including 6% to 8.5% by weight, based on the weight of the glass composition or cellular glass product produced therefrom.

Additionally, the glass composition used to produce the cellular glass product comprises Na₂O, K₂O, and/or Li₂O collectively in an amount of at least 12% by weight. In certain exemplary embodiments, the glass composition comprises Na₂O, K₂O, and/or Li₂O collectively in an amount of less than 18% by weight. In certain exemplary embodiments, the glass composition comprises Na₂O, K₂O, and/or Li₂O collectively in an amount of 12% to 18% by weight, including 12.5% to 17% by weight, including 12.8% to 16.5%, including 13% to 16% by weight, including 14% to 18% by weight, and including 14% to 16.5% by weight, based on the weight of the glass composition or cellular glass product produced therefrom.

The glass composition further comprises SO₃ in an amount of at least 0.2% by weight. In certain exemplary embodiments, the glass composition comprises SO₃ in an amount of less than 1% by weight. In certain exemplary embodiments, the glass composition comprises SO₃ in an amount of greater than 0.2% to 0.9% by weight, including 0.3% to 0.8% by weight, including 0.4% to 0.9%, including 0.2% to 0.8%, and including 0.4% to 0.7% by weight, based on the weight of the glass composition or cellular glass product produced therefrom.

The glass composition used to produce the cellular glass product further comprises Fe₂O₃ in an amount of at least 1% by weight. In certain exemplary embodiments, the glass composition comprises Fe₂O₃ in an amount of less than 6% by weight. In certain exemplary embodiments, the glass composition comprises Fe₂O₃ in an amount of 1% to 5% by weight, including 1.2% to 4.7% by weight, including 1.3% to 4.5% by weight, including 2% to 6%, including 2.5% to 5.8% by weight, including 2.8% to 5.5% by weight, and including 2.8% to 4.5% by weight, based on the weight of the glass composition or cellular glass product produced therefrom.

In certain exemplary embodiments, in addition to MnO, the glass composition comprises BaO+SrO collectively in an amount less than 0.3% by weight. In certain exemplary embodiments, the glass composition comprises BaO+SrO in an amount of 0% to 0.1% by weight (i.e., trace amounts), including 0.01% to 0.2% by weight, including 0.05% to 0.25% by weight, including 0.1% to 0.2%, and including 0.1% to 3% by weight. It is to be understood that in certain embodiments, higher amounts of BaO+SrO (e.g., 0.3% to 2% by weight) may be present as discussed previously with respect to various embodiments including lower amounts of MnO.

The glass composition used to produce the cellular glass product may further comprise TiO₂ in an amount of less than 0.5% by weight. In certain exemplary embodiments, the glass composition comprises TiO₂ in an amount of 0.01% to 0.5% by weight, including 0.05% to 0.4% by weight, including 0.1% to 0.3% by weight, including 0.15% to 0.2%, including less than 0.4% by weight, including less than 0.3% by weight, including less than 0.2% by weight, and including less than 0.1% by weight, based on the weight of the glass composition or cellulose glass product produced therefrom.

In certain embodiments, the amount of MnO (along with other oxides) is determined by XRF (X-Ray Fluorescence). Those of ordinary skill will understand that XRF measures the amount of Mn, and is often reported as MnO, regardless of the actual oxidation state. For the purposes of this application, the Mn detected by XRF will be discussed as though in the MnO oxidation state.

The following Table lists exemplary ranges of oxide content for a cellular glass product made according to the general inventive concepts.

TABLE 1

| | Range A | | Range B | |
|---|---|---|---|---|
| | Lower | Upper | Lower | Upper |
| | wt. % | wt. % | wt. % | wt. % |
| SiO₂ | 55 | 75 | 55 | 75 |
| CaO + MgO | 4 | 11 | 4 | 11 |
| Na₂O + K₂O + Li₂O | 12 | 18 | 12 | 18 |
| MnO | 0.4 | 10 | 2 | 10 |
| Al₂O₃ | 1 | 10 | 1 | 10 |
| Fe₂O₃ | 1 | 6 | 1 | 6 |
| SO₃ | 0.2 | 0.9 | 0.2 | 0.9 |
| BaO + SrO | 0.3 | 2 | 0 | 0.3 |

In any of the various exemplary embodiments, the cellular glass product comprises MnO in an amount of 2% to 10% by weight and has a thermal conductivity that is less than or equal to 0.06 W/mK, less than or equal to 0.05 W/mK, and less than or equal to 0.045 W/mK, including from 0.033 W/mK to 0.042 W/mK. For purposes of the disclosure herein, thermal conductivity is measured in accordance with the EN 12667 standard.

In any of the exemplary embodiments, the cellular glass product may comprise MnO in an amount of 2% to 10% by weight and have a density that is less than 300 kg/m³, including between 75 kg/m³ and 300 kg/m³, including between 90 kg/m³ and 250 kg/m³, including between 100 kg/m³ and 200 kg/m³, including between 80 kg/m³ and 140 kg/m³, including less than 200 kg/m³, and including less than 150 kg/m³. In any of the exemplary embodiments, the cellular glass product comprises MnO₂ in an amount of 2% to 10% by weight and is at least substantially (i.e., at least 80%) closed cell, or completely (i.e., 100%) closed cell. In any of the exemplary embodiments, the cellular glass product comprises MnO in an amount of 2% to 10% by weight and has a compressive strength greater than 0.4 MPa, including 0.4 MPa to 2.5 MPa, including 0.4 MPa to 2.4 MPa, including 0.4 MPa to 2 MPa, including 0.4 MPa to 1.75 MPa, including 0.45 MPa to 1.5 MPa, including 0.5 MPa to 1.45 MPa, including 0.6 to 1.4 MPa, including 0.7 to 1.3 MPa, including 0.8 MPa to 1.25 MPa, and including 0.85 MPa to 1.2 MPa. For purposes of the disclosure herein, compressive strength is measured in accordance with the EN 826 standard.

In any of the various exemplary embodiments, the foamable glass for producing a cellular glass product has a room temperature thermal conductivity of less than 1.1 W/mK, including less than 1.0 W/mK. In any of the various exemplary embodiments, the foamable glass has an elastic modulus of greater than 60 GPa, including greater than 65 GPa, including greater than 70 GPa, and including greater than 75 GPa.

The general inventive concepts also contemplate methods of recycling scrap material and methods of producing a cellular glass product comprising at least a portion of scrap material and/or recycled cullet. The methods incorporate scrap material in the production of cellular glass products that include increased amounts of oxidizing agents (e.g., MnO, MnO₂), while retaining certain desirable properties of the cellular glass products, as discussed herein. It is to be understood the foregoing discussion of the glass composition applies equally to the methods described herein. That is, the methods according to the concepts discussed herein employ the glass compositions and ingredient (e.g., oxide) values discussed herein.

Various exemplary embodiments disclose methods for producing a cellular glass product comprising at least a portion of scrap material or recycled cullet. The method comprises providing a source of raw glass materials in a melter, wherein the raw glass materials include two or more of virgin glass material, scrap material, and recycled cullet; providing a source of an oxidizing agent into the melter and mixing the oxidizing agent with the raw glass materials to form a glass melt, wherein the oxidizing agent is included in an amount to achieve a predetermined level of the oxidizing agent in the glass melt; cooling the glass melt; and subjecting a resulting glass material to a cellular glass production process. In certain exemplary embodiments, the glass comprises the oxidizing agent in an amount of at least 2% by weight, including 2% to 10% by weight. In certain embodiments, the scrap material may be combined with raw/virgin glass material in a melter to form a combined glass melt.

In any of the exemplary embodiments, the scrap glass material may be present in the raw materials or glass melt in an amount of 10% to 60%, including 20% to 50%, and in some exemplary embodiments, the scrap material may be present in amount greater than 60%, including 100%. In certain exemplary embodiments, recycled cullet can make up about 20% to about 60% of the material in the melter, including 20% to 40%, and in certain instances, about 36% of the total weight. In certain exemplary embodiments, scrap material and recycled cullet are combined in amount of up to 85%, including 20% to 85%, and including 40% to 80% by weight. In certain exemplary embodiments, the virgin material and scrap material are present in a weight ratio of 9:1 to 2:3, including, for example, 4:1, to 1:1.

As previously mentioned, there is an unmet need for methods that result in a reduction of scrap cellular glass material that ultimately is sent to landfills and/or reducing the demand for virgin glass-making materials for cellular glass production (by recycling scrap or waste or post-consumer glass). The concepts discussed herein are based, in part, on the discovery that scrap material can be reintroduced to a process for cellular glass production (whether continuous or batch) by introducing oxidizing agents directly into a melter and increasing the amount of oxidizing agent in the melt to levels above that which was previously feasible for cellular glass insulation. The concepts discussed herein are also based, in part, on the discovery that increased levels of MnO in the glass composition used for foaming, do not negatively impact the thermal conductivity and strength of the glass and as a consequence do also not negatively impact the thermal conductivity and strength of the cellular glass product produced by foaming such glass. This makes MnO₂ (discussed herein as MnO in the cellular glass product) the oxidizer of choice to enable elevated levels of scrap and/or recycled cullet.

### Examples

The following examples illustrate exemplary embodiments and/or features of the methods and compositions according to the general inventive concepts. The examples are given solely for the purpose of illustration and are not to be construed as limitations of the general inventive concepts, as many variations thereof are possible without departing from the spirit and scope of the general inventive concepts. All exemplified amounts are weight percentages based upon the total weight of the composition, unless otherwise specified.

Sample glass compositions A-D (detailed in Table 2) were designed to comprise approximately 4% by weight, MnO, which was introduced in the melter during the formation process.

The glass compositions were melted, annealed, and poured in bars (for E-modulus measurements) and pucks (for thermal conductivity measurements). Measured glass composition data (in % by weight) for Samples A-D and two control glasses (Control 1 and 2) are shown in Table 2.

TABLE 2

| XRF | | | | | | | | | | | | |
|---|---|---|---|---|---|---|---|---|---|---|---|---|
| normalized | SiO₂ | Al₂O₃ | CaO | MgO | Na₂O | K₂O | SO₃ | Fe₂O₃ | BaO | TiO₂ | SrO | MnO |
| Control 1 | 67.04 | 5.09 | 5.21 | 1.85 | 13.52 | 1.62 | 0.43 | 3.69 | 0.03 | 0.04 | 0.00 | 1.46 |
| Control 2 | 68.17 | 4.95 | 5.19 | 2.30 | 12.74 | 2.08 | 0.40 | 3.08 | 0.72 | 0.05 | 0.03 | 0.30 |
| Sample A | 64.33 | 5.16 | 5.49 | 1.68 | 13.59 | 1.71 | 0.42 | 3.57 | 0.00 | 0.00 | 0.00 | 4.04 |
| Sample B | 65.74 | 5.13 | 4.66 | 1.24 | 13.68 | 1.67 | 0.42 | 3.43 | 0.00 | 0.00 | 0.00 | 4.03 |
| Sample C | 64.94 | 5.13 | 5.51 | 1.66 | 13.14 | 1.70 | 0.41 | 3.45 | 0.00 | 0.00 | 0.00 | 4.05 |
| Sample D | 65.39 | 5.15 | 5.49 | 1.68 | 12.66 | 1.68 | 0.42 | 3.48 | 0.00 | 0.00 | 0.00 | 4.05 |

Various measured properties of the annealed glass products are shown in Table 3. E-modulus, G-modulus (shear modulus), and Poisson's ratio were measured according to ASTM E1876. Thermal conductivity (ASTM E1225) was measured by a Heat Flux Meter and CTE is measured by dilatometry according to ASTM E228.

TABLE 3

| | | | | Thermal | |
|---|---|---|---|---|---|
| | E- | G- | | conduc- | |
| | modulus | modulus | Poisson's | tivity | CTE |
| | [GPa] | [GPa] | ratio | [W/mK] | [μm/m · K] |
| Control 1 | 72 | 30 | 0.19 | 1.036 | 8.60 |
| Control 2 | 73 | 31 | 0.18 | | 8.65 |
| Sample A | 71 | 30 | 0.19 | 1.002 | 9.07 |
| Sample B | 69 | 29 | 0.18 | 0.999 | 8.77 |
| Sample C | | | | 0.993 | 8.84 |
| Sample D | 66 | 28 | 0.17 | 1.006 | 8.61 |

Samples A-E were also melted, quenched, ground with carbon, and foamed in a vertical tube furnace. The compositional analysis (in % by weight) including sulfate retention is shown in Table 4.

TABLE 4

| XRF | | | | | | | | | | | | |
|---|---|---|---|---|---|---|---|---|---|---|---|---|
| normalized | SiO₂ | Al₂O₃ | CaO | MgO | Na₂O | K₂O | SO₃ | Fe₂O₃ | BaO | TiO₂ | SrO | MnO |
| Sample A | 63.98 | 5.36 | 5.68 | 2.17 | 12.58 | 1.80 | 0.59 | 3.10 | 0.13 | 0.27 | 0.09 | 4.25 |
| Sample B | 66.08 | 5.27 | 4.76 | 1.64 | 12.51 | 1.79 | 0.50 | 3.11 | 0.10 | 0.25 | 0.08 | 3.90 |
| Sample C | 64.36 | 5.71 | 5.54 | 2.25 | 12.21 | 1.81 | 0.53 | 2.93 | 0.10 | 0.26 | 0.08 | 4.23 |
| Sample D | 64.91 | 5.39 | 5.63 | 2.21 | 11.71 | 1.82 | 0.51 | 3.14 | 0.10 | 0.25 | 0.09 | 4.26 |
| Sample E | 66.33 | 4.06 | 4.17 | 1.29 | 12.99 | 1.31 | 0.52 | 4.19 | 0.97 | 0.24 | 0.06 | 3.86 |

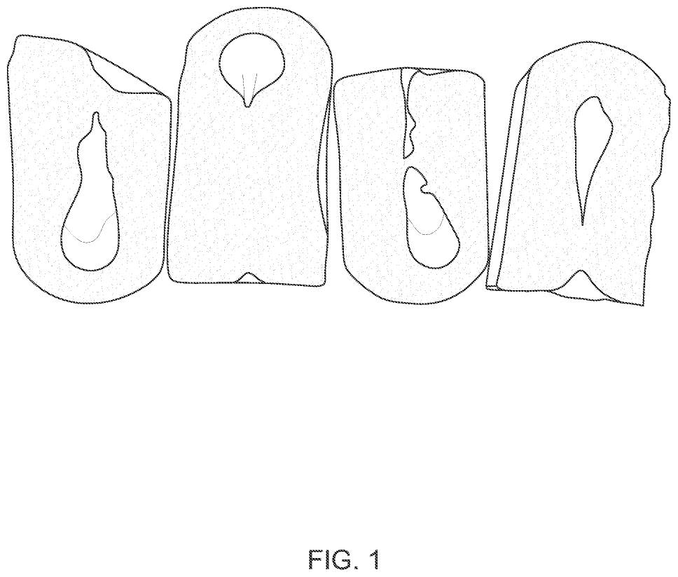

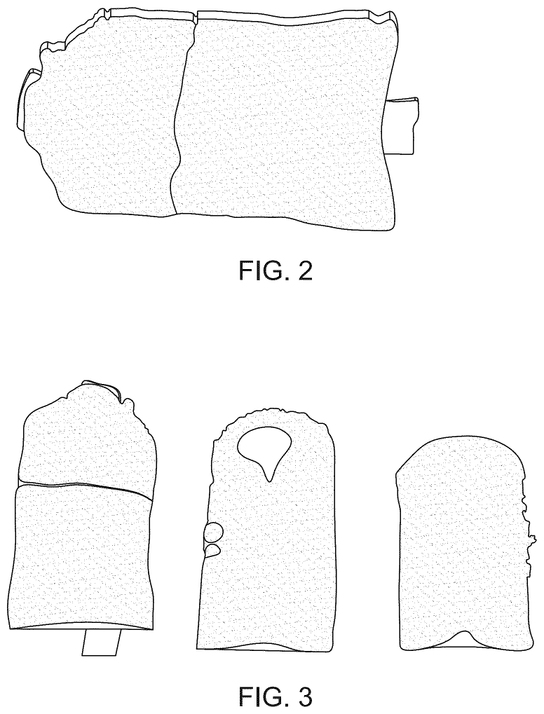

A small foam test was conducted to test the foamability of the glass, and to provide an indication of foam height, cell structure, viscosity, etc. For this test, 50 g of ground glass with carbon black was loaded in a cylindrical crucible with 8 cm diameter. The crucible was loaded into a preheated vertical tube furnace with an argon atmosphere. After 20 minutes of stabilization time at elevated temperature (630° C.) to uniformly heat the powder batch, the temperature was increased at a rate of 8° C./min. A laser distance meter measured the batch/foam height through an optical window. When the foam was considered to be at optimal foam height, the foam was extracted from the furnace and loaded into an insulated box for annealing. FIG. 1 shows that the sample glasses foamed well, though Sample D performed somewhat worse than the other samples (e.g., lower height, coarse cells). FIG. 2 shows a control foam made from a conventional glass mixture. All figures were manually resized to represent the same scale (˜equal width of the foam). Many of the foams have a “bottom fold” cavity. Those are to be considered an effect of the small scale mostly, rather than an indication of a glass property.

The conventional cellular glass sample of FIG. 2 and Sample C were tested for hydrolytic resistance according to International Standard ISO 719:2020. Both were determined to be hydrolytic resistance class HGB 3.

A higher manganese samples were prepared using 10% manganese oxide, the composition of the glass is shown in Table 5 (in % by weight). FIG. 3 shows foam blocks made using increased manganese content.

TABLE 5

| XRF | | | | | | | | | | | | |
|---|---|---|---|---|---|---|---|---|---|---|---|---|
| normalized | SiO₂ | Al₂O₃ | CaO | MgO | Na₂O | K₂O | SO₃ | Fe₂O₃ | BaO | TiO₂ | SrO | MnO |
| Sample F | 56.55 | 5.251 | 7.516 | 2.77 | 11.55 | 1.57 | 0.78 | 3.303 | 0.14 | 0.25 | 0.071 | 10.3 |

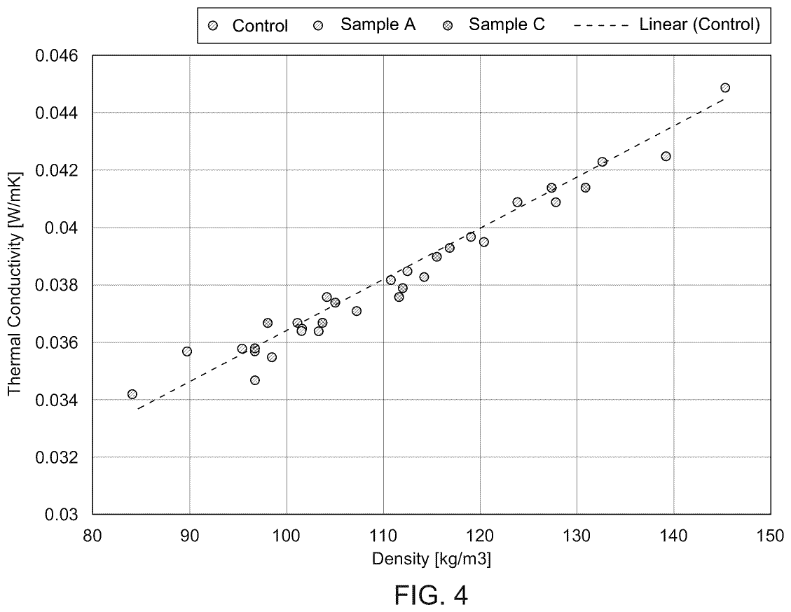

Control glass 1, Sample A, and Sample C were molten, ground and used to form blocks of cellular glass and were finished to a size of 60×45×10 cm blocks. FIG. 4 is a schematic showing the sections of each block that were used for each of a series of tests of the cellular glass products. FIG. 4 shows the results of thermal conductivity measurement (EN 12667) of the foams. All foam thermal conductivities line up without showing significant deviation. The overall trend shows very similar slopes for all glasses. Particularly, the test Samples demonstrated thermal conductivity values ranging from 0.034 W/mK to 0.043 W/mK over a foam density of 84 kg/m³ to ˜140 kg/m³.

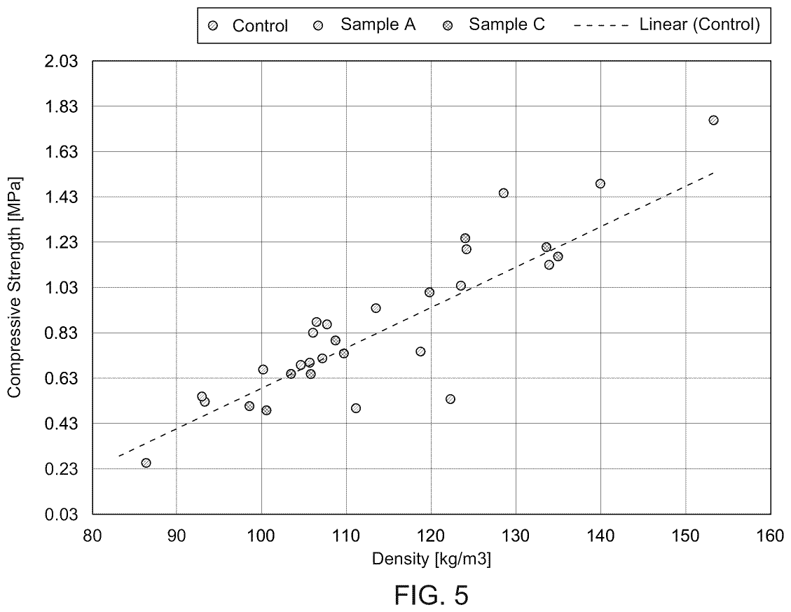

FIG. 5 shows the results of compressive strength measurements (according to EN 826). It is important to note that compressive strength measurements are often quite variable under production standards and pilot size batches would be expected to show even greater variability. That being said, the measurements show that both Sample A and C perform on the same standard as the conventional production glass. The test Samples demonstrated compressive strength values within a range of 0.25 N/mm² (i.e., 0.25 MPa) and 1.5 N/mm² (i.e., 1.5 MPa) over a foam density of 90 kg/m³ to 140 kg/m³. Comparatively, Control 1 demonstrated compressive strength values within a similar range.

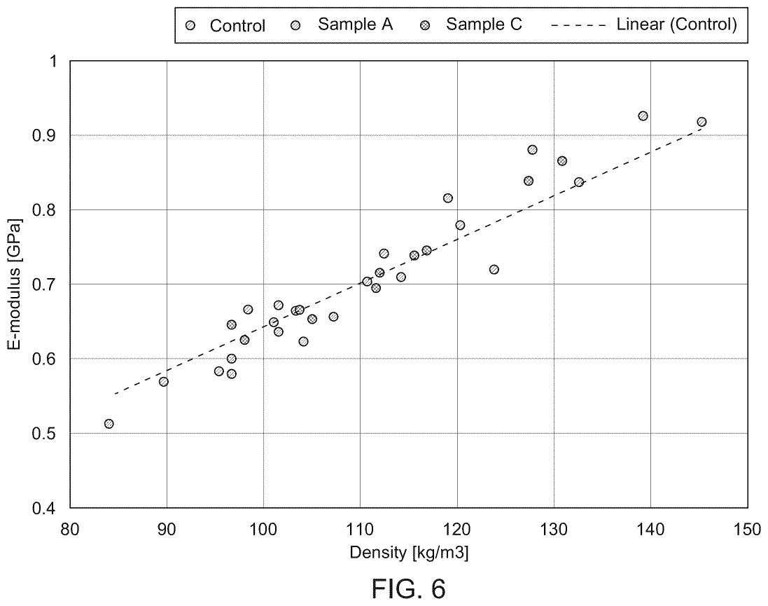

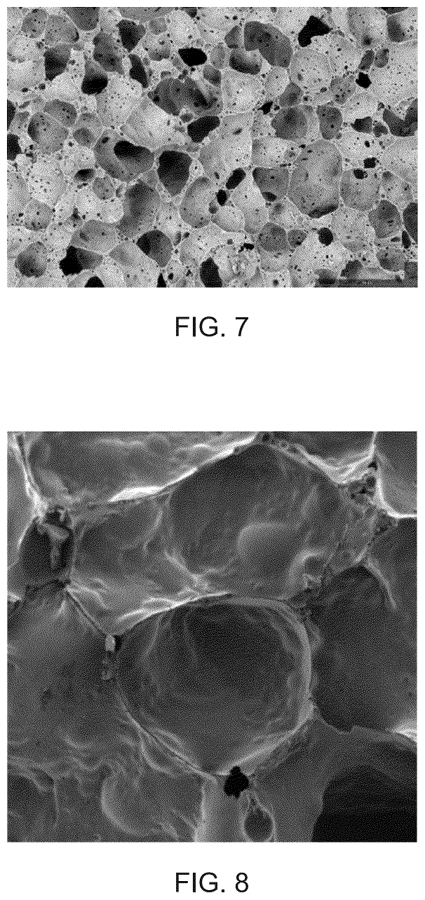

As illustrated in FIG. 6, Samples A and C demonstrated elastic modulus values within a range of 0.5 GPa and 1 GPa over a foam density of 90 kg/m³ to 140 kg/m³. Comparatively, Control 1 demonstrated elastic modulus values within a similar range.

Water Vapor durability. Lambda plates for Sample A and Comparative glasses 1 and 2 were mounted freely above a water bath at 90° ° C. The weight gain (due to water uptake, in case cell walls corrode and water can condense inside the foam) was monitored over 4 weeks' time. Water vapor durability tests according to EN 12086 showed that Sample A performed similar to or even slightly better than control blocks of similar density.

Sample glass composition G (detailed in Table 6 in % by weight) was designed to comprise approximately 0.5% by weight, MnO in combination with BaO+SrO of approximately 1% by weight, according to certain embodiments discussed herein. The glass was melted, annealed, and foamed for testing. The samples each measured at a foam density of 113-118.7 kg/m³.

TABLE 6

| XRF | | | | | | | | | | |
|---|---|---|---|---|---|---|---|---|---|---|
| normalized | SiO₂ | Al₂O₃ | CaO + MgO | Na₂O + K₂O | SO₃ | Fe₂O₃ | BaO | TiO₂ | SrO | MnO |
| Sample G(1) | 66.32 | 5.03 | 8.78 | 14.25 | 0.38 | 3.06 | 1.12 | 0.09 | 0.03 | 0.46 |
| Sample G(2) | 66.32 | 5.03 | 8.78 | 14.25 | 0.38 | 3.06 | 1.12 | 0.09 | 0.03 | 0.46 |
| Sample G(3) | 66.32 | 5.03 | 8.78 | 14.25 | 0.38 | 3.06 | 1.12 | 0.09 | 0.03 | 0.46 |

Table 7 shows the experimental results for each of three sections of sample G glass with respect to E-modulus, G-modulus, and Poisson's ratio for the glass as well as the thermal conductivity, compressive strength and coefficient of thermal expansion for the foam produced from the glass. This demonstrates that foam glass products can be made including glass compositions with about 0.4% by weight MnO in combination with BaO+SrO values between about 0.3 and 2% by weight (made according to the general inventive concepts) and retain important/desirable properties for cellular glass insulation.

TABLE 7

| | | | | Thermal | | Compressive |
|---|---|---|---|---|---|---|
| | E-modulus | G-modulus | Poisson's | conductivity | CTE | strength |
| | [GPa] | [GPa] | ratio | [W/mK] | [μm/m.K] | [N/mm²] |
| Sample G(1) | 82 | 31 | 0.34 | 0.04 | 8.60 | 0.96 |
| Sample G(2) | 76 | 29 | 0.32 | 0.039 | 8.61 | 0.86 |
| Sample G(3) | 75 | 28 | 0.32 | 0.04 | 8.63 | 0.88 |

A control glass made using a conventional glass mixture was melted and annealed along with two experimental glasses (Samples I and J). The experimental glasses were designed to comprise MnO of approximately 0.4 to 2% by weight and BaO+SrO of 0.3 to 2% by weight. The composition of the glasses is shown in Table 8 (in % by weight).

TABLE 8

| XRF | | | | | | | | | | |
|---|---|---|---|---|---|---|---|---|---|---|
| normalized | SiO₂ | Al₂O₃ | CaO + MgO | Na₂O + K₂O | SO₃ | Fe₂O₃ | BaO | TiO₂ | SrO | MnO |
| Sample H | 68.17 | 4.95 | 7.49 | 14.82 | 0.40 | 3.08 | 0.72 | 0.05 | 0.03 | 0.3 |
| (control) | | | | | | | | | | |
| Sample I | 67.61 | 5.33 | 8.30 | 13.98 | 0.22 | 2.88 | 0.88 | 0.08 | 0.01 | 0.69 |
| Sample J | 67.55 | 5.22 | 8.50 | 14.10 | 0.34 | 2.92 | 0.88 | 0.07 | 0.01 | 0.40 |

Table 9 shows the results of measuring E-modulus, G-modulus, poisson's ratio, and CTE for the glasses shown in Table 8. Those bulk glass properties are suitable for producing foam glass products. This demonstrates that foam glass products can be made including glass compositions with about 0.4% by weight MnO in combination with BaO+SrO values between about 0.3 and 2% by weight (made according to the general inventive concepts) and retain important/desirable properties for cellular glass insulation in comparison to conventional glasses.

TABLE 9

| | E-modulus | G-modulus | Poisson's | CTE |
|---|---|---|---|---|
| | [GPa] | [GPa] | ratio | [μm/m · K] |
| Sample H | 73 | 31 | 0.18 | 8.65 |
| Sample I | 74 | 31 | 0.19 | 8.62 |
| Sample J | 71 | 30 | 0.19 | 8.90 |

Table 10 shows the results of measured FeO and SO₃ weight percent, measured after melting in either an air atmosphere or in the presence of a nitrogen atmosphere for Samples G-J. Thus demonstrates that similar amounts of total Fe are present in the melted glass.

TABLE 10

| | |
|---|---|
| Air | N₂ |

| | FeO | SO₃ | FeO | SO₃ |
|---|---|---|---|---|
| | wt. % | wt. % | wt. % | wt. % |
| Sample G | 0.273 | 0.424 | | |
| Sample G | | | 0.396 | 0.457 |
| Sample H | 0.35 | 0.414 | | |
| Sample I | 0.448 | 0.264 | | |
| Sample J | 0.398 | 0.387 | | |
| Sample I | | | 0.547 | 0.148 |
| Sample J | | | 0.366 | 0.414 |

As used in the description of the size composition disclosed herein, the singular forms “a,” “an,” and “the” are intended to include the plural forms as well, unless the context clearly indicates otherwise. All references incorporated herein by reference are incorporated in their entirety unless otherwise stated. Unless otherwise indicated (e.g., by use of the term “precisely”), all numbers expressing quantities, properties such as molecular weight, reaction conditions, and so forth as used in this disclosure are to be understood as being modified in all instances by the term “about.” Accordingly, unless otherwise indicated, the numerical properties set forth in this disclosure are approximations that may vary depending on the desired properties sought to be obtained in embodiments described herein.

As disclosed and suggested herein, the general concepts of the present disclosure relate to and contemplate improvements in cellular glass products and, more particularly, to methods of producing cellular glass products using modified scrap cellular glass and/or cellular glass having an increased amount of an oxidizer (e.g., MnO or MnO₂). The scope of the general concepts is not intended to be limited to the particular exemplary embodiments shown and described herein. From the disclosure given, those skilled in the art will not only understand the general concepts and their attendant advantages but will also find apparent various changes and modifications to the compositions and methods. It is sought, therefore, to cover all such changes and modifications that fall within the spirit and scope of the general concepts, as described and suggested herein, and any equivalents thereof.

1. A cellular glass product produced from a glass composition comprising:
a source of MnO in an amount of 2% to 10% by weight;
SiO₂ in an amount from 55% to 75% by weight;
Al₂O₃ in an amount from 1% to 10% by weight;
CaO+MgO in an amount from 4% to 11% by weight;
Na₂O+K₂O+Li₂O in an amount from 12% to 18% by weight; and
BaO+SrO in an amount of 0% to 0.3% by weight, wherein the cellular glass product meets at least one of the following properties;
the cellular glass product is a closed cell foam;
the cellular glass product has a density of about 75 kg/m³ to 300 kg/m³;
the cellular glass product has a thermal conductivity of 0.033 W/mK to 0.06 W/mK; and
the cellular glass product has a compressive strength of 0.4 MPa to 2.5 MPa.

2. The cellular glass product according to claim 1, wherein the glass composition comprises SiO₂ in an amount from 60% to 70% by weight.

3. The cellular glass product according to claim 1, wherein the glass composition comprises Al₂O₃ in an amount from 2% to 7% by weight.

4. The cellular glass product according to claim 1, wherein the glass composition comprises CaO+MgO in an amount from 5% to 9% by weight.

5. The cellular glass product according to claim 1, wherein the glass composition further comprises SO₃ in an amount of 0.2% to 0.9% by weight.

6. The cellular glass product according to claim 1, wherein the glass composition further comprises Fe₂O₃ in an amount from 1% to 6% by weight.

7. The cellular glass product according to claim 1, wherein the glass composition further comprises TiO₂ in an amount of 0% to 0.5% by weight.

8. The cellular glass product according to claim 1, wherein the cellular glass product comprises at least 20% by weight of scrap material or recycled cullet.

9. The cellular glass product according to claim 1, wherein the cellular glass product comprises 30% to 85% by weight of scrap material or recycled cullet.

10. The cellular glass product according to claim 1, wherein the cellular glass product has a thermal conductivity of 0.033 W/mK to 0.042 W/mK.

11. The cellular glass product according to claim 1, wherein the cellular glass product has a compressive strength of 0.5 MPa to 1.45 MPa.

12. The cellular glass product according to claim 1, wherein the source of MnO is present in the glass composition in an amount of 3% to 8% by weight.

13. The cellular glass product according to claim 1, wherein the source of MnO is present in the glass composition an amount of 4% to 6% by weight.

14. A cellular glass product produced from a glass composition comprising:
a source of MnO in an amount of 0.4% to 2% by weight;
BaO+SrO in an amount of 0.3% to 2% by weight; and at least one of the following:
SiO₂ in an amount from 55% to 75% by weight;
Al₂O₃ in an amount from 1% to 10% by weight;
CaO+MgO in an amount from 4% to 11% by weight;
Na₂O+K₂O+Li₂O in an amount from 12% to 18%% by weight, wherein the cellular glass product meets at least one of the following:
the cellular glass product is a substantially closed cell foam;
the cellular glass product has a density of about 75 kg/m³ to 300 kg/m³;
the cellular glass product has a thermal conductivity of 0.033 W/mK to 0.06 W/mK; and
the cellular glass product has a compressive strength of 0.4 MPa to 2.5 MPa.

15. The cellular glass product according to claim 14, wherein the glass composition comprises SiO₂ in an amount from 55% to 75% by weight; Al₂O₃ in an amount from 1% to 10% by weight; CaO+MgO in an amount from 4% to 11% by weight; Na₂O+K₂O+Li₂O in an amount from 12% to 18%% by weight; SO₃ in an amount of 0.2% to 0.9% by weight; Fe₂O₃ in an amount from 1% to 6% by weight; and TiO₂ in an amount of 0% to 0.5% by weight.

16. The cellular glass product according to claim 14, wherein the cellular glass product is a closed cell foam and has a density of about 75 kg/m³ to 300 kg/m³; a thermal conductivity of 0.033 W/mK to 0.06 W/mK; and a compressive strength of 0.4 MPa to 2.4 MPa.

17. The cellular glass product of claim 14, wherein the glass composition used to form the cellular glass product comprises at least 20% by weight of scrap material or recycled cullet.

18. A method of producing a cellular glass product comprising at least a portion of scrap material or recycled cullet, the method comprising:
providing a source of raw glass materials in a melter, wherein the raw glass materials include two or more of virgin glass material, scrap material, and recycled cullet;
providing a source of an oxidizing agent into the melter and mixing the oxidizing agent with the raw glass materials to form a glass melt, wherein the oxidizing agent is included in an amount to achieve a predetermined level of the oxidizing agent in the glass melt;
cooling the glass melt; and
subjecting a resulting glass material to a cellular glass production process.

19. The method of claim 18, wherein the predetermined level of the oxidizing agent is 2% to 10% by weight.

20. The method of claim 18, wherein the predetermined level of the oxidizing agent is 0.4% to 2% by weight and the glass material further comprises a combined amount of BaO+SrO in an amount of 0.3% to 2% by weight.

21. The method of claim 18, wherein the glass material comprises:
SiO₂ in an amount from 55% to 75% by weight;
Al₂O₃ in an amount from 1% to 10% by weight;
CaO+MgO in an amount from 4% to 11% by weight;
Na₂O+K₂O+Li₂O in an amount from 12% to 18%% by weight;
SO₃ in an amount of 0.2% to 0.9% by weight;
Fe₂O₃ in an amount from 1% to 6% by weight; and
TiO₂ in an amount of 0% to 0.5% by weight.

22. The method of claim 18, wherein the oxidizing agent is MnO₂, MnO, or combinations thereof.

23. The method of claim 18, wherein the virgin material and the scrap material are present in the foamable glass material in a ratio of 9:1 to 2:3 by weight.

24. The method of claim 18, wherein the cellular glass product comprises one or more of the following properties:
a. the cellular glass product is a substantially closed cell foam;
b. the cellular glass product has a density of about 75 kg/m³ to 300 kg/m³;
c. the cellular glass product has a thermal conductivity of less than 0.06 W/mK; and
d. the cellular glass product has a compressive strength of 0.4 MPa to 2.5 MPa.

25. The cellular glass product of claim 1, wherein the glass composition used to form the cellular glass product comprises at least 20% by weight of scrap material or recycled cullet.
